(19) United States
(12) Patent Application Publication
(10) Pub. No.: US 2015/0184760 A1
(43) Pub. Date: Jul. 2, 2015

(54) INJECTION-COMPRESSION MOLDED ROTORS

(71) Applicant: Waters Technologies Corporation, Milford, MA (US)

(72) Inventors: Mark W. Moeller, Norton, MA (US); Joseph D. Antocci, Leominster, MA (US); Robert A. Jencks, Mendon, MA (US)

(73) Assignee: Waters Technologies Corporation, Milford, MA (US)

(21) Appl. No.: 14/408,403

(22) PCT Filed: Jun. 3, 2013
(86) PCT No.: PCT/US13/43841

§ 371 Date: Dec. 16, 2014

Related U.S. Application Data
(60) Provisional application No. 61/661,456, filed on Jun. 19, 2012.

(51) Int. Cl. F16K 5/04; B29C 45/56; F16K 11/085

(52) U.S. Cl. CPC F16K 5/045; F16K 11/085; B29C 45/561; B29K 2507/04

(57) ABSTRACT

A shear valve assembly for use in a high performance liquid chromatography system. The shear valve assembly includes a stator having a plurality of first fluid-conveying features; and a rotor having one or more second fluid-conveying features. The rotor is movable, relative to the stator, between a plurality of discrete positions such that, in each of the discrete positions, at least one of the one or more second fluid-conveying features overlaps with multiple ones of the first fluid conveying features to provide for fluid communication therebetween. The rotor, including the second fluid-conveying features, is formed by injection-compression molding.

### RELATED APPLICATIONS

This application claims priority to and benefit of U.S. Provisional Patent Application No. 61/661,456 entitled “Injection-Compression Molded Rotors,” filed Jun. 19, 2012, which is incorporated by reference herein in its entirety.

### TECHNICAL FIELD

The invention relates generally to injection-compression molded rotors. More particularly, the invention relates to injection-compression molded rotors for rotary shear valve assemblies for liquid chromatography applications.

### BACKGROUND

Many analytic systems incorporate valves for controlling fluid flow. An example is the use of shear valves in some chromatography systems. These valves often must retain fluid integrity, that is, such valves should not leak fluids. As a valve is cycled, however, between positions, the loads placed on the moving parts cause wear.

Some valves are subjected to high pressures. For example, sample injector valves in high performance liquid chromatography (HPLC) apparatus, are exposed to pressures approximately 1,000 to 5,000 pounds per square inch (psi), as produced by common solvent pumps. Higher pressure chromatography apparatus, such as ultra high performance liquid chromatography (UHPLC) apparatus, have solvent pumps that operate at pressures up to 15,000 psi or greater. As the pressure of a system increases, wear and distortion of a valves components, such as a rotor and a stator, tends to increase, and the valve's expected lifetime may be reduced.

### SUMMARY

This invention arises, in part, from the realization that rotors for shear valve assemblies can advantageously be formed via injection-compression molding. Such configurations can provide for rotors which have a more uniform structure, are less susceptible to wear, and/or are less prone to contribute to carryover than conventional rotors. The use of injection-compression molding can also help to reduce internal stresses in the rotors, and can be a less expensive alternative to method of forming conventional rotors.

In one aspect, the invention provides a shear valve assembly for use in a high performance liquid chromatography system. The shear valve assembly includes a stator having a plurality of first fluid-conveying features; and a rotor having one or more second fluid-conveying features. The rotor is movable, relative to the stator, between a plurality of discrete positions such that, in each of the discrete positions, at least one of the one or more second fluid-conveying features overlaps with multiple ones of the first fluid conveying features to provide for fluid communication therebetween. The rotor, including the second fluid-conveying features, is formed by injection-compression molding.

Another aspect features a method that includes injecting molten resin into a tool cavity, and compressing the resin within the tool cavity to form a rotor for a shear valve assembly. The rotor is formed with one or more fluid-conveying features for fluid communication with a stator.

A further aspect provides a rotor for a rotary shear valve assembly. The rotor has:

a substantially planar surface with one or more fluid-conveying features for fluid communication with a stator. The fluid-conveying features are formed via an injection-compression molding process.

Implementations may include one or more of the following features.

In some implementations, the rotor is formed of a polymer filled with 20% to 50% carbon fiber (30% carbon fiber) by weight.

In certain implementations, the polymer is polyether-ether-ketone.

In some implementations, the one or more second fluid-conveying features include one or more arcuate grooves.

In certain implementations, the one or more arcuate grooves have a width of approximately 0.005 inches to 0.020 inches (e.g., approximately 0.008 inches).

In some implementations, the one or more arcuate grooves have a depth of 0.005 inches to 0.020 inches (e.g., 0.008 inches).

In certain implementations, a seal formed between contacting surfaces of the rotor and the stator substantially prevents fluidic leakage up to at least 15,000 psi (e.g., between 15,000 psi and 19,000 psi).

In some implementations, injecting molten resin into a tool cavity includes injecting molten resin into a tool cavity between a stationary die and a movable die.

In certain implementations, compressing the resin includes displacing the movable die toward the stationary die to compress the resin within the tool cavity and thereby forming the rotor having the one or more fluid-conveying features.

In some implementations, the stationary die or the movable die includes tooling features for forming the one or more fluid-conveying features in the rotor.

In certain implementations, the movable die includes first tooling features for forming the one or more fluid-conveying features in the in the rotor, and the stationary die includes second tooling features for forming holes in the rotor for mounting the rotor to a drive shaft.

In some implementations, the one or more fluid-conveying features includes one or more arcuate grooves, and the stationary die or the movable die includes tooling features for forming the one or more arcuate grooves.

In certain implementations, the one or more arcuate grooves have one or more dimensions that are 0.010 inches or less in size.

In some implementations, the stationary die includes overflow ports and excess resin is forced out of the tool cavity through the overflow ports as the resin is compressed for promoting a uniform flow of the resin within the cavity.

In certain implementations, the overflow ports are equally spaced apart in a radial array for promoting a symmetrical flow of the resin.

In some implementations, the resin includes polyether-ether-ketone.

In certain implementations the resin comprises 20% to 50% carbon fiber (e.g., 30% carbon fiber) by weight.

In some implementations, the carbon fibers have a diameter of 6 microns to 8 microns (e.g., 7 microns).

In certain implementations, the carbon fibers have a length of 0.002 inches to 0.020 inches.

In some implementations, the one or more fluid-conveying features comprise one or more arcuate grooves.

In certain implementations, the one or more fluid-conveying features have a width and a depth of less than 0.020 inches (e.g., less than 0.010 inches).

In some implementations, the one or more fluid-conveying features have a width of approximately 0.005 inches to 0.020 inches (e.g., approximately 0.008 inches).

In certain implementations, the one or more fluid-conveying features have a depth of 0.005 inches to 0.020 inches (e.g., 0.008 inches).

In some implementations, the one or more fluid conveying features have one or more dimensions that are 0.010 inches or less in size.

Implementations can provide one or more of the following advantages.

In some implementations, carryover can be reduced. For example, by molding rotor grooves rather than machining, carbon fiber is fully encapsulated by resin which has a direct impact on lowering carryover. Machining shears and exposes the carbon fibers which contribute to carryover, which can adversely affect chromatographic results.

In certain implementations, injection-compression molding of rotors can provide for manufacturing cost savings. In this regard, it can be less expensive to mold features rather than to machine them, particularly when the features are below 0.010 inches in size. Injection molding alone generally cannot “pack out” such small features.

In some implementations, internal stresses which lead to warpage can be reduced. For example, injection molding by itself can cause internal stresses to a molded part due to non-symmetrical filling. Internal stresses can interfere with the ability to maintain a flat surface on the molded part during subsequent lapping and polishing processes. However, by adding a compression step, these internal stresses can be reduced.

In certain implementations, the additional of a compression step during fabrication of a valve rotor has the ability to further flatten out carbon fibers at the surface of the rotor. Carbon fiber laying flat as opposed to being “on end,” has a tendency to wear less and more uniformly leading to a longer operating life for the shear valve assembly. This flattening effect can also help to remove flow lines which indicate that the resin mix is less uniform.

Other aspects, features, and advantages are in the description, drawings, and claims.

### BRIEF DESCRIPTION OF THE DRAWINGS

FIG. 1A and FIG. 1B are side and a cross-sectional views, respectively, of an implementation of a rotary shear valve assembly comprising a stator, housing for a rotor assembly, and drive shaft clamp.

FIG. 1C is an exploded view of the rotary shear valve assembly.

FIG. 1D is an isometric view the rotary shear valve assembly from the end with the drive shaft clamp.

FIG. 2A and FIG. 2B are top and bottom views, respectively, of a stator of the rotary shear valve assembly of FIG. 1A.

FIG. 2C is a perspective view of the stator of FIG. 2A with a fluid coupling.

FIG. 3A is side view of an implementation of a drive shaft of the rotor assembly.

FIG. 3B is a side view of the drive shaft with springs about the drive shaft stem.

FIG. 3C is a top view of the drive shaft from the end with the pins.

FIG. 4A is an isometric view of an implementation of the rotor.

FIG. 4B is a top view of the rotor.

FIG. 4C is a section view of the rotor in accordance with line A-A in FIG. 4B.

FIG. 4D is a view of detail region A in FIG. 4B.

FIG. 4E is a view of detail region B in FIG. 4C.

FIG. 5 illustrates an injection molding process for forming a conventional rotor puck.

FIGS. 6A-6D are side views of an injection-compression molding apparatus which illustrate an injection-molding process.

Like reference numbers indicate like elements.

### DETAILED DESCRIPTION

Rotary shear valve assemblies described herein have a rotor formed via an injection-compression molding process. The use of the injection-compression molding process allows fluid-conveying features (e.g., grooves) of the rotor to be formed by molding rather than by machining This can be beneficial particularly in instances in which the rotor is molded from a carbon fiber filled polymer where machining of the rotor (e.g., to form the fluid-conveying features) might otherwise shear and expose the carbon fibers, which, in turn, can contribute to carryover. The use of the injection-compression molding process can also provide a rotor that has a more uniform (homogeneous) structure (e.g., with uniformly distributed carbon fibers and substantially free of resin flow lines).

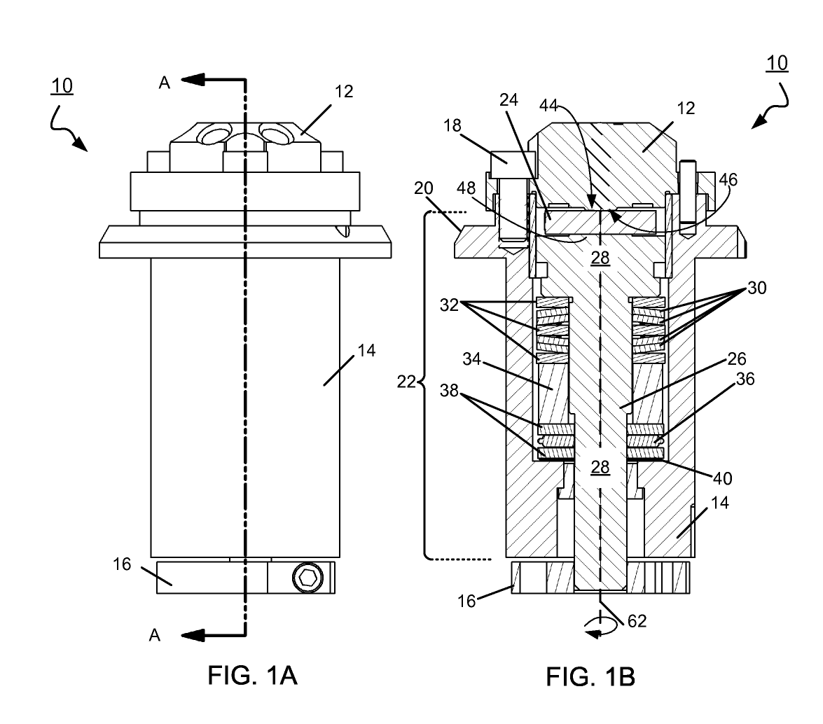

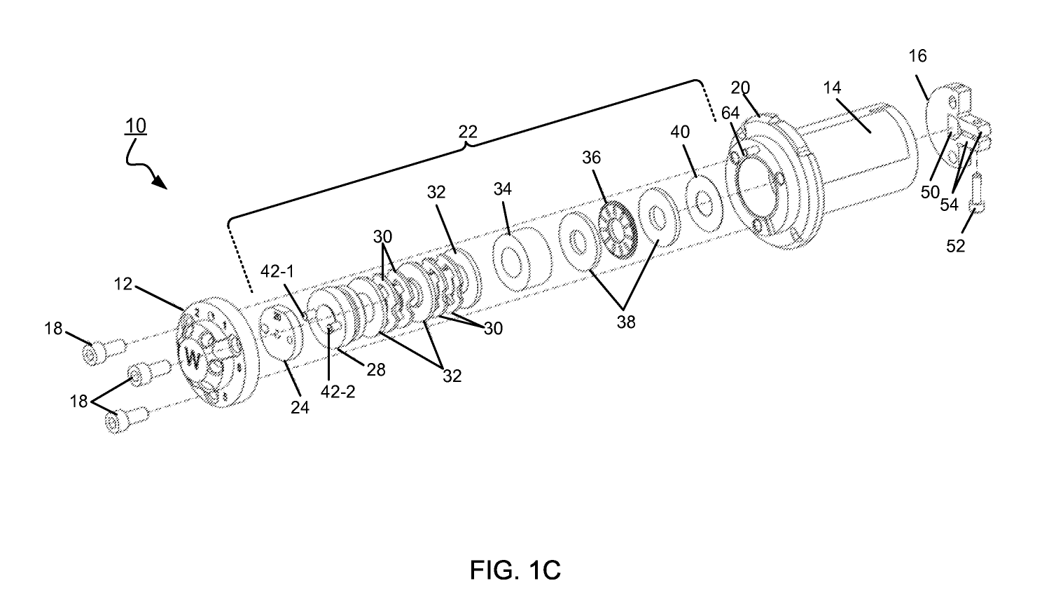

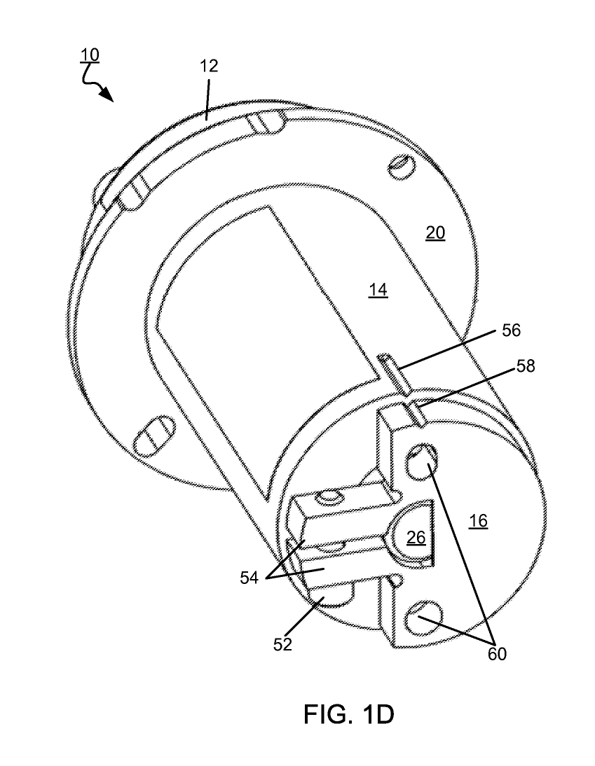

FIG. 1A shows a side view of an implementation of a rotary shear valve assembly 10 including a stator 12 secured to one end of a housing 14 and a drive shaft clamp 16 at the opposite end of the housing 14. FIG. 1B shows a cross-sectional view of the rotary shear valve assembly 10 taken along line A-A in FIG. 1A, FIG. 1C shows an exploded view of the rotary shear valve assembly 10, and FIG. 1D shows the rotary shear valve assembly 10 from the end with the drive shaft clamp 16. Mounting screws 18 secure the stator 12 to a flange 20 of the housing 14. The housing 14 substantially encloses a rotor assembly 22 comprised of a disk-shaped rotor 24, a drive shaft 26 with a head portion 28, four springs 30 grouped in two sets of two separated and flanked by washers 32, a spacer 34, a thrust bearing 36 sandwiched between bearing washers 38, and, optionally, a shim 40.

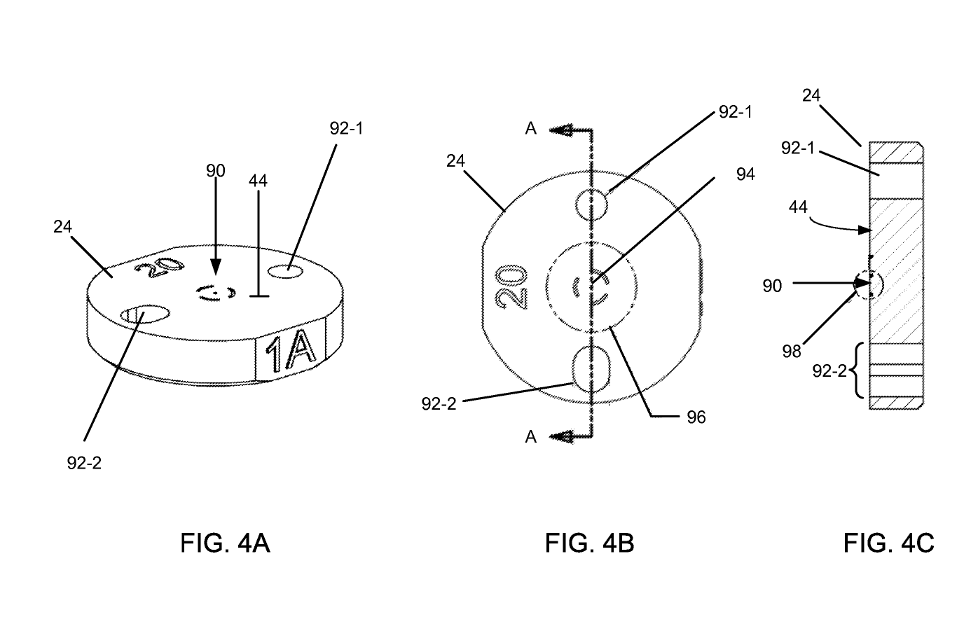

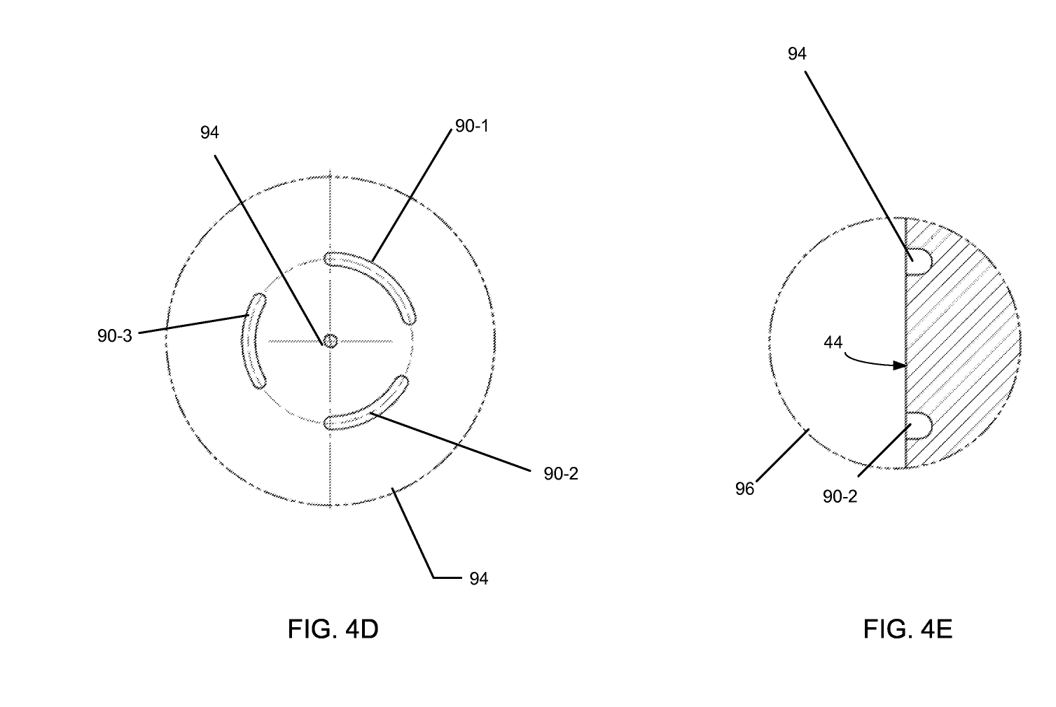

The rotor 24 is coupled to the head portion 28 of the rotor assembly 22. Extending orthogonally from the distal face of the head portion 28 are two pins 42-1, 42-2 that enter corresponding openings (FIG. 4A) in the rotor 24. A substantially planar surface 44 of the rotor 24 abuts an opposing surface 46 of the stator 12. In addition, the rotor 24 sits on a raised region or dais 48 of the head portion 28. The dais 48 concentrates the force applied to the rotor and is preferably smaller than the base surface of the rotor 24, so that the rotor 24 may slightly teeter on the dais 48 to facilitate complete contact between the rotor and stator surfaces 44, 46.

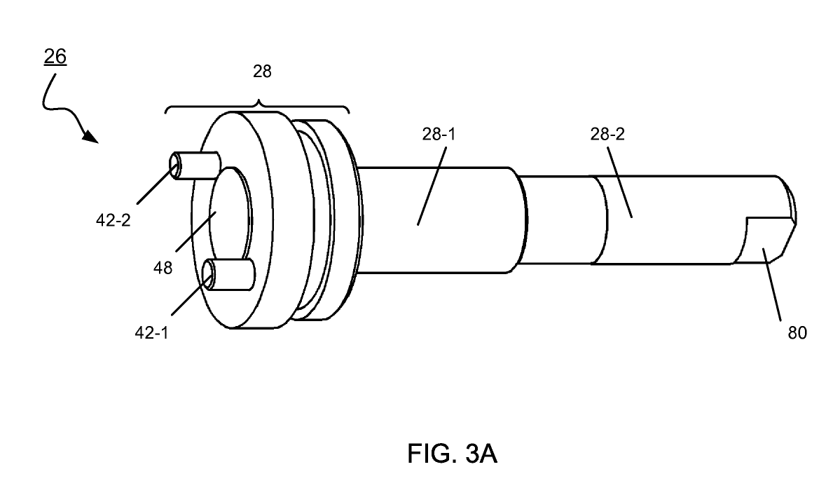

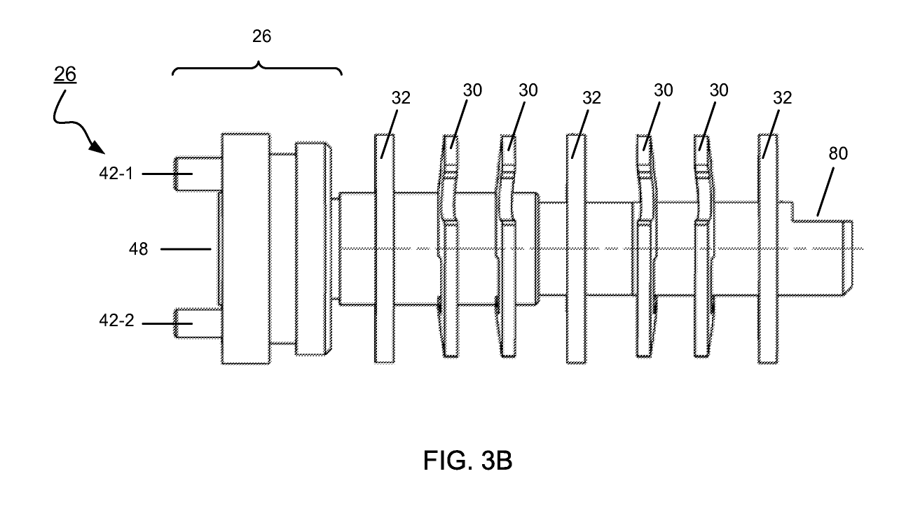

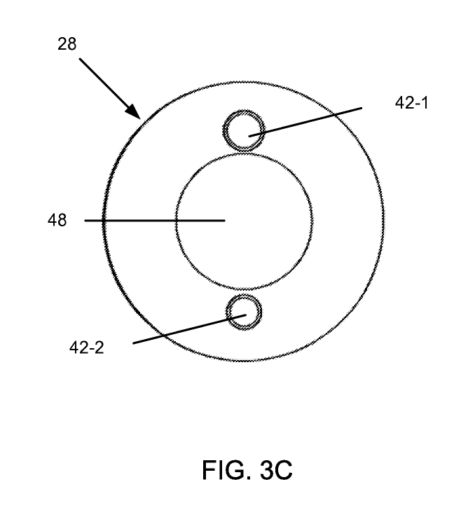

The drive shaft 26 extends through an opening at the base of the housing 14. The end of the drive shaft 26 extends into an opening 50 of the drive shaft clamp 16, which is appropriately shaped to closely receive a notched end (FIG. 3A) of the drive shaft. The end of the drive shaft 26 has a notch. A threaded screw 52 passes through pincers 54, which tightens the opening 50 about the drive shaft's end to hold the drive shaft 26 securely. When secured properly, the end of the drive shaft 26 is almost flush with the plane of the clamp 16. Alignment grooves 56, 58 on the housing 14 and clamp 16, respectively, are used to position these units appropriately for coupling the clamp 16 to the draft shaft 26. A drive mechanism (not shown) couples to holes 60 in the clamp 16 in order to provide a rotating force about a central axis 62 (FIG. 1B).

The compression of the springs 30 translates to an axial force to the rotor 24, urging the rotor surface 44 against the stator surface 46 and maintaining a fluidic seal at the interface of these surfaces 44, 46. In one implementation, the springs 30 are clover springs. Other types of springs can be used, for example, Belleville washers, without departing from the principles described herein. In one implementation, the compressive load achieved by the springs 30 is approximately 600 lbs. and is designed to produce a seal between the rotor and stator that can prevent leakage at fluidic pressures at least as great as 20,000 psi. For example, in UPLC instruments, the fluidic pressure typically ranges between 15,000 psi and 20,000 psi. The springs 30 maintain the applied force applied throughout the rotation of the drive shaft 26 and the rotor 24.

The spacer 34 serves to separate the thrust bearing 36 and bearing washers 38 from the spring stack comprised of the springs 30 and spring washers 32. The thrust bearing 36 and bearing washers 38 facilitate rotation of the drive shaft. The shim 40 is used to achieve the desired amount of compression along the axis of the draft shaft, with additional shims being added to the drive shaft until the compressive load produced by the springs 30 reaches the desired target of, for example, approximately 600 lbs.

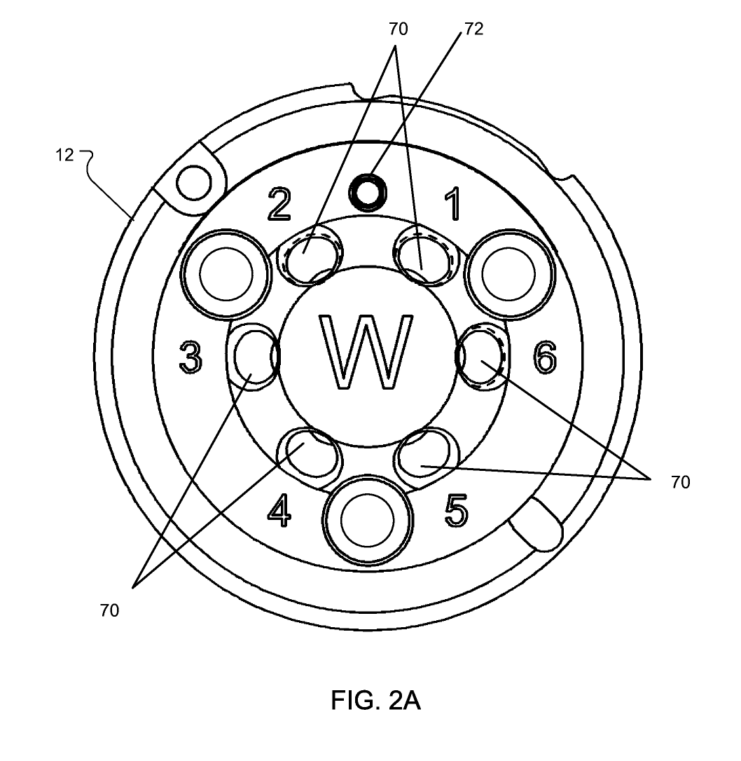

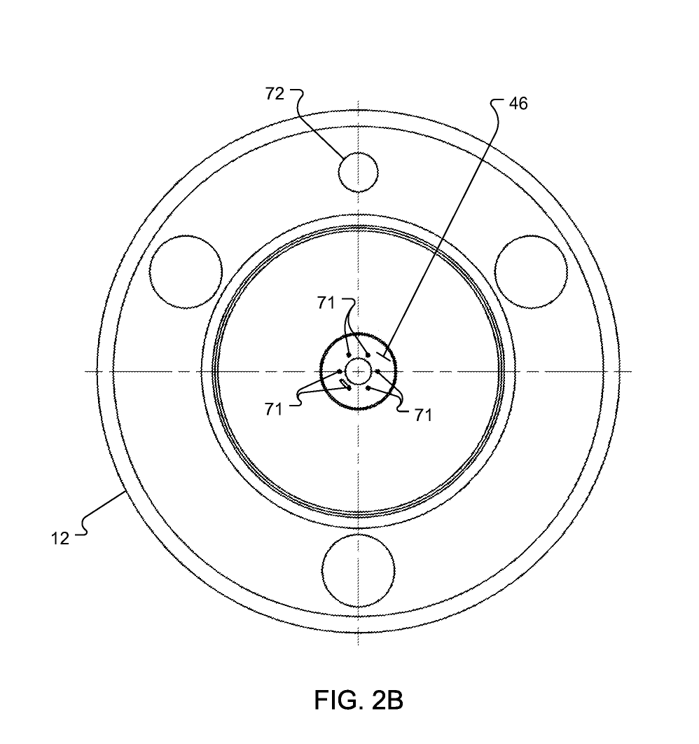

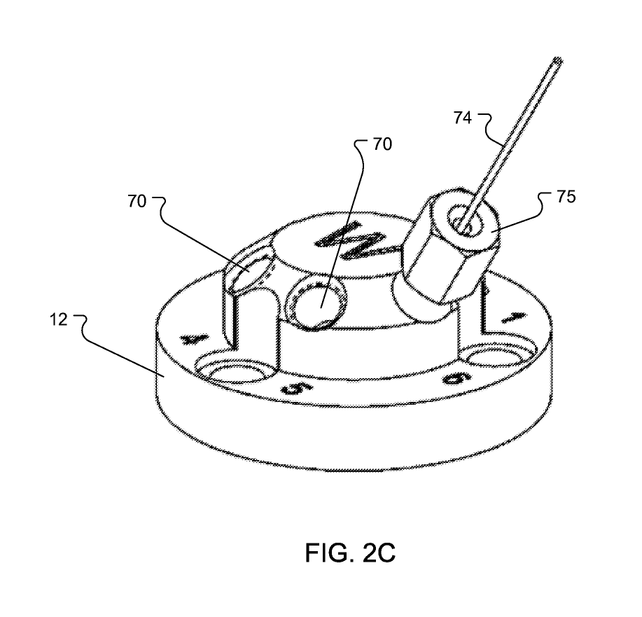

Referring to FIGS. 2A and 2B, the stator 12 has six ports 70 (FIG. 2A), each extending to an opening 71 at the contact surface 46 (FIG. 2B) of the stator 12. Each port 70 couples to a fluidic tube or channel 73 (FIG. 2C) by which fluid flows to or from the rotary shear valve assembly 10. The port 70 can be coupled to the fluidic tube 73 via a fitting 75. Rotation of the rotor 24 with respect to the stator 12 changes the connectivity of the ports 70, as described in more detail below. The stator 12 also has a guide hole 72 for receiving an alignment pin 64 (FIG. 1C) extending from the leading raised ring of the housing 14.

The openings 71 can be approximately 0.006 inches diameter and can be arranged in a circular array of diameter 0.1 inches. The external diameter of the stator 12 can be about 1.5 inches. The stator 12 can be manufactured from stainless steel (e.g., 316 stainless steel), or other corrosion resistant alloy. The stator contact surface 46 can be coated with a wear resistant material, for example diamond-like carbon (DLC).

FIG. 3A shows an isometric view of an implementation of the rotor assembly 22, including the head portion 28 of the drive shaft 26. The head portion 28 has a generally disk-like shape with the dowel pins 42-1, 42-2 (generally, 42) and the dais 48 extending from a surface thereof. The pins 42 are diametrically opposite of each other; that is, considering the pins 42 to be endpoints of an arc on the circumference of this circle having its center at the center of the dais 48, the arc defined by the pins is semicircular (i.e., 180 degrees). These pins 42 enable torque transfer, and thus, rotation of the rotor assembly 22 as the drive shaft 26 rotates about the rotational axis 62. In one implementation, the pins 42 are equal in length and pin 42-1 has a larger diameter than pin 42-2. Having one pin larger than the other pin provides a keying feature that ensures only one orientation by which the head portion 28 can couple to the rotor 24. Corresponding through-holes in the rotor 24 slideably receive the pins 42 in order to mount and align the rotor 24 relative to the drive shaft 26.

Also shown, the drive shaft 26 has a first portion 26-1 (adjacent the head portion 28) with a greater diameter than a second portion 26-2. At the end of the drive shaft 26 is a notch 80, sized to fit closely into the opening 50 (FIG. 1C) of the drive shaft clamp 16. FIG. 3B shows the rotor assembly 22 with the various springs 30 (here, e.g., clover springs) and washers 32 slipped over the drive shaft 26 (and uncompressed). For each set of two, the concave sides of the two clover springs 30 face the same direction. In addition, the concave sides of the two clover springs 30 in each set face in the direction of the concave sides of the two clover springs 30 in the other set. Preferably, the two springs in each set are in alignment with each other during assembly, although the two sets need not be in alignment with each other.

FIG. 3C shows an end view of the leading face of the head portion 28 with the two pins 42-1, 42-2 and centrally located dais 48. In one implementation, each pin 42 extends approximately 0.16 inches from a surface of the head portion 28, pin 42-1 having an approximately 0.109 inch diameter, pin 42-2 having an approximately 0.093 inch diameter, and the centers of the pins being 0.500 inches apart, with each pin being 0.250 inches from the center of the dais 48. In addition, in this implementation, the dais 48 is raised approximately 0.012 inches from the surface of the head portion 28. Other pin sizes and locations can be employed without departing from the principles described herein.

FIG. 4A shows an isometric view of the disk-like shaped rotor 24 with a set of rotor grooves 90 disposed centrally on the contact surface 44 of the rotor 24. The length and position of the grooves 90 in the rotor surface 44 align the grooves 90 for coupling to various ports 70 of the stator 12 to other ports 70 of the stator 12 when the rotor 24 and stator 12 are in particular rotational alignments. In this implementation, there are three rotor grooves (the rotor shear valve assembly being configured as an injection valve). Other implementations can have one, two, or more than three rotor grooves, for use in other types of valves, such as vent valves and column manager valves.

In addition, the rotor 24 has two diametrically opposite openings 92-1, 92-2 (corresponding to the two pins of the drive shaft). The opening 92-1, referred to as a mating hole, is adapted to receive the smaller pin 42-2 of the rotor assembly 22 closely with tight tolerance. In one implementation, the mating hole 92-1 has a diameter of approximately 0.095 inches for closely receiving the 0.093 diameter implementation of the smaller pin 42-2. The opening 92-2 is an elliptically shaped slot adapted to receive the larger pin 42-1 of the two pins, with a greater measure of tolerance along the direction of the major axis of the slot than along the minor axis. In one implementation, the minor axis of the slot 92-2 is approximately 0.110 inches wide for receiving the 0.109 diameter implementation of the larger pin 42-1. The rotor 24 can slide onto the pins 42 of the head portion 28 without pressing. The ends of the pins 42 within the holes 92 of the rotor are approximately flush with the contact surface 44 of the rotor.

FIG. 4B shows a top view of the rotor 24 with a cross-sectional line A-A bisecting the openings 92-1, 92-2 and center point 94 of the rotor and passing though the ends of two of the rotor grooves. The center point 94 is the center of rotation of the rotor 24. The center point 94 can have a diameter of 0.005 inches to 0.015 inches. In one implementation, the center point 94 has an approximately 0.010 inch diameter. Detail region 96 encircles the rotor grooves 90 and center point 94.

FIG. 4C shows a cross-section of the rotor 24 taken along the line A-A of FIG. 4B. In the cross-section, each opening 92-1, 92-2 extends entirely through the rotor 24. In addition, to provide a sense of scale, the center point 94 and rotor grooves 90 appear as dark dots immediately below the surface 44 of the rotor 24. Detail region 98 surrounds the center point 94 and the one of the rotor grooves 90.

FIG. 4D show a view of the detail region 96 of FIG. 4B, including the three rotor grooves 90-1, 90-2, and 90-3 (generally, 90). The rotor grooves 90 are arcuate in shape, and reside equidistant from the central point 94. In one implementation, the rotor groove 90-1 forms an approximately 74 degree arc and rotor grooves 90-1 and 90-2 form 60 degree arcs, each groove being approximately 0.005 inches to 0.020 inches in width, e.g., 0.008 inches in width. FIG. 4E shows a view of detail region 98 of FIG. 4C, the rotor groove 90-3 (representative of all grooves 90) being a shallow channel and the center point being a shallow hemisphere formed in the surface 44 of the rotor 24. In one implementation, the depths of the grooves 90 and center point 94 are approximately 0.005 inches to 0.020 inches, e.g., 0.008 inches. The external diameter of the rotor 24 can be about 0.5 inches to 1.0 inches, e.g., 0.7 inches. The rotor 24 has a thickness of 0.120 inches to 0.150 inches, e.g., 0.141 inches.

The rotor 24 can be manufactured from polyether-ether-ketone, such as PEEK™ polymer (available from Victrex PLC, Lancashire, United Kingdom), filled with 20% to 50% carbon fiber by weight, e.g., 30% carbon fiber by weight. The carbon fibers have a diameter of 6 microns to 8 microns, e.g., 7 microns, and a length of 0.002 inches to 0.020 inches. Notably, the rotor 24 is formed in an injection-compression molding process.

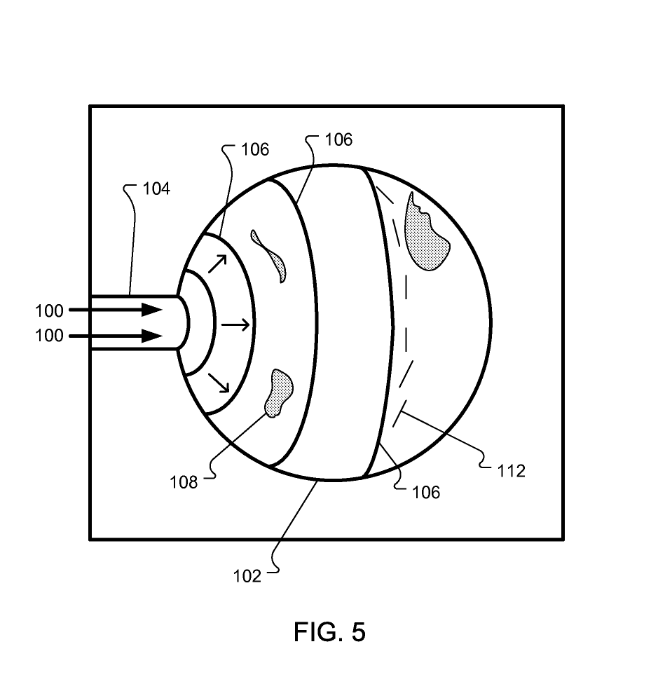

Conventional rotors are often manufactured by first injection molding a rotor puck (a pre-part), and then performing machining processes and polishing steps performed to complete the part. FIG. 5 illustrates an injection molding process for forming a conventional rotor puck. As shown in FIG. 5, a resin flow 100 is injected into a tool cavity 102 through a side gate 104. As illustrated in FIG. 5, the injection molding process can produce resin flow lines 106 which represent non-uniformities in the structure of the rotor puck being formed. Between flow lines 106 there are darker regions 108 which are resin rich and/or include carbon fiber on end (i.e., with a longitudinal axis of the carbon fibers extending substantially perpendicular to the plane of the rotor contact surface). Such an orientation of the carbon fibers contributes to wear, since the carbon fibers tend to wear more quickly at exposed ends. In addition, other regions include carbon fibers 112 having an orientation which follows the flow lines 106, and, consequently, the carbon fibers 112 are not uniformly distributed throughout the part, but, instead, exhibit a tendency to form grains, which can contribute to uneven wear. Injection molding by itself can cause internal stresses to the part due to non-symmetrical filling. These internal stresses can interfere with maintaining a flat part during subsequent lapping and polishing processes.

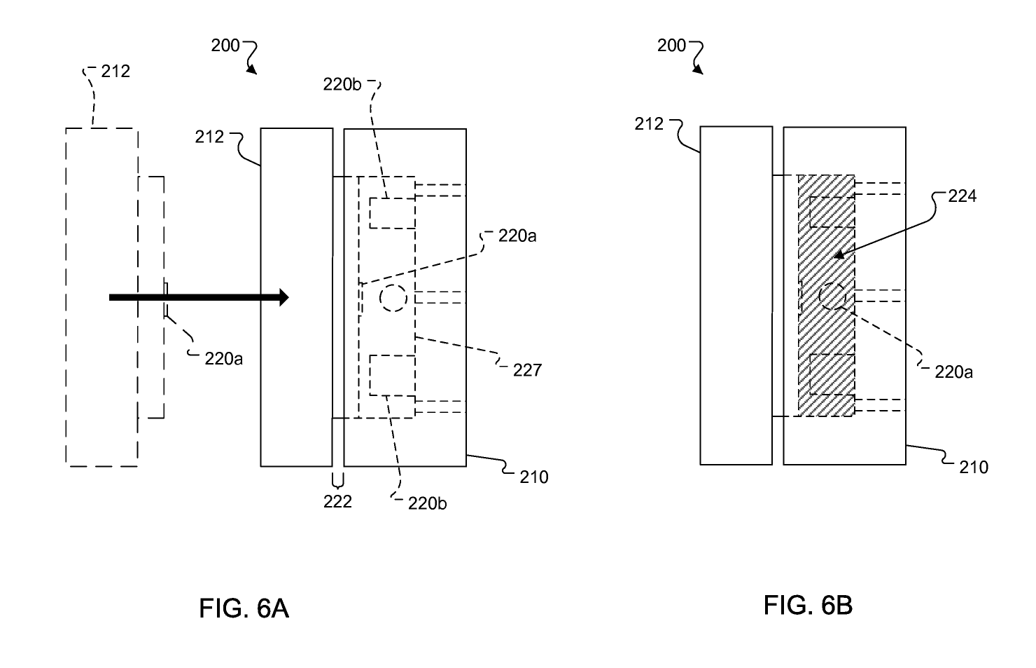

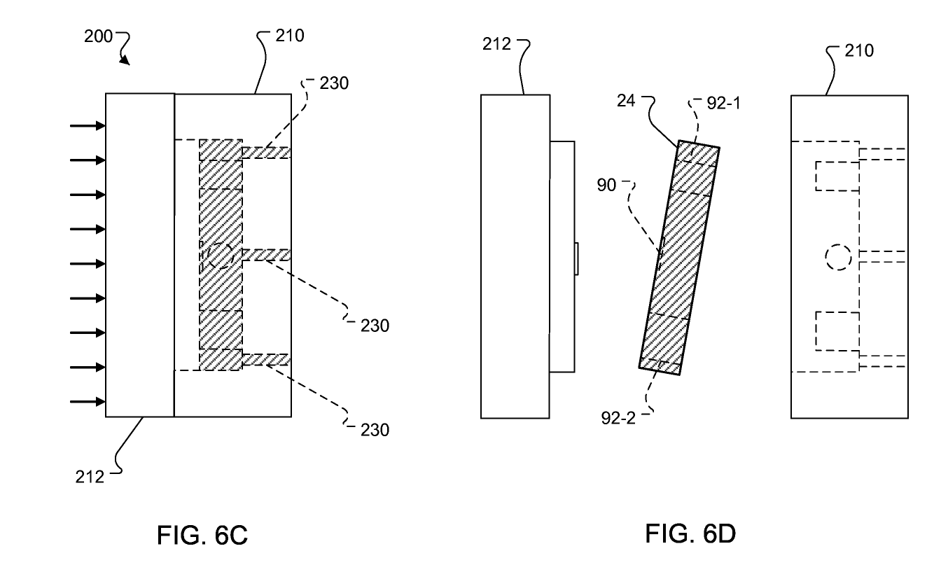

FIGS. 6A-6D illustrate an injection-compression molding process and apparatus for forming a rotor 24 in accordance with the invention. Referring to FIG. 6A, an injection-compression molding apparatus 200 includes a stationary die 210 and a movable die 212. The injection-compression molding apparatus 200 includes features 220a that form the grooves 90 and center point 94 (FIG. 4A) and features 220b that form the openings 92-1, 92-2 (FIG. 4A) in the rotor 24 during the injection-compression molding process. These features 220a, 220b may be inserts disposed within the stationary die 210 and/or the movable die 212. For example, in one implementation, the stationary die 210 includes replaceable inserts for forming the openings 92-1, 92-2 and the movable die 212 includes an insert for forming the grooves 90 and center point 94. Alternatively or additionally, the features 220a, 220b can be machined into the stationary die 210 and/or the movable die 212. The stationary die 210 and the movable die 212 can be formed from P20 tool steel.

In the injection-compression molding process, the movable die 212 is moved into a first position relative to the stationary die 210. As shown in FIG. 6A, in the first position, a compression gap 222 is maintained between the movable die 212 and the stationary die 210. With the movable die 212 in the first position, molten resin 224 (e.g., molten PEEK polymer containing 20% to 50% carbon fiber by weight (e.g., 30% carbon fiber by weight)) is injected, into a cavity 226 that is formed by a recess 227 in the stationary die 210 and the movable die 212, as illustrated in FIG. 6B. In this regard, the molten resin 224 is injected, at a temperature of 644° F. and 700° F. and a pressure of 1,000 psi to 10,000 psi through a side gate 228 in the stationary die 210 from a nozzle attached to an injection apparatus (not shown).

Then, the side gate 228 is closed and the volume of the cavity 226 is reduced, to compress the melted resin in the cavity, by moving the movable die 212 toward a second position relative to the stationary die 210, as illustrated in FIG. 6C. In this regard, the movable die 212 is moved 0.020 inches to 0.060 inches toward the stationary die 210, thereby closing the compression gap 222 and compressing the injected resin to form the rotor. As the resin is compressed (e.g., at pressures of 10,000 psi to 25,000 psi), excess material exits the cavity 226 through symmetrical overflow ports 230 in the stationary die 210. In one implementation, the stationary die 210 includes four overflow ports 230 spaced equally in a radial array. The use of symmetrical overflow ports 230 helps to further reduce the presence of resin flow lines and help to contribute to a more uniform flow, and, thus, a final molded product with a more homogeneous structure, as compared to a conventional injection molded part. As result, flow lines may be avoided, carbon fiber lay may be more random, and more carbon fiber may lay flat rather than on end.

This compression step causes flow lines, from the injection of the resin, to disperse and causes the carbon fibers to lay more flat (i.e., with the longitudinal axes of the fibers extending substantially parallel to the plane of the rotor contact surface 44) for better wear. The compression step also helps to resin to “pack out” better, i.e., as compared to conventional injection molding, to help fill intricate details such as the rotor grooves. This allows the rotor grooves 90 to be molded, and, molding the rotor grooves, rather than machining, helps to ensure that the carbon fiber remains fully encapsulated by the polymer which helps to reduce carryover. Machining, on the other hand, shears and exposes the carbon fibers which can contribute to carryover. Such machining is typically required as a subsequent processing step in the formation of conventional injection molded rotors. The compressed polymer is allowed to cool, and, then, the mold is opened by moving the movable die 212 away from the stationary die 210, and the molded part (the rotor 24, including grooves 90, center point 94, and openings 92-1, 92-2) is ejected, as illustrated in FIG. 6D. Following ejection, the rotor contact surface 44 is lapped down 0.006 inches to 0.010 inches and polished.

While the invention has been shown and described with reference to specific implementations, it should be understood by those skilled in the art that various changes in form and detail may be made therein without departing from the spirit and scope of the invention as recited in the accompanying claims.

1-10. (canceled)

11. A method comprising:
injecting molten resin into a tool cavity
compressing the resin within the tool cavity to form a rotor for a shear valve assembly, the rotor being formed with one or more fluid-conveying features for fluid communication with a stator.

12. The method of claim 11, wherein injecting molten resin into a tool cavity comprises injecting molten resin into a tool cavity between a stationary die and a movable die.

13. The method of claim 12, wherein compressing the resin comprises displacing the movable die toward the stationary die to compress the resin within the tool cavity and thereby forming the rotor having the one or more fluid-conveying features.

14. The method of claim 12, wherein the stationary die or the movable die includes tooling features for forming the one or more fluid-conveying features in the rotor, the one or more fluid-conveying features comprising one or more arcuate grooves.

15. The method of claim 12, wherein the movable die includes first tooling features for forming the one or more fluid-conveying features in the in the rotor, and wherein the stationary die includes second tooling features for forming holes in the rotor for mounting the rotor to a drive shaft.

16. (canceled)

17. The method of claim 14, wherein the one or more arcuate grooves have one or more dimensions that are about 0.010 inches or less in size.

18. The method of claim 11, wherein the stationary die comprises overflow ports, wherein excess resin is forced out of the tool cavity through the overflow ports as the resin is compressed for promoting a uniform flow of the resin within the cavity.

19. The method of claim 18, wherein the overflow ports are equally spaced apart in a radial array for promoting a symmetrical flow of the resin.

20. (canceled)

21. The method of claim 11, wherein the resin comprises about 20% to about 50% carbon fiber by weight.

22. The method of claim 11, wherein the resin comprises about 30% carbon fiber by weight.

23. A rotor for a rotary shear valve assembly, the rotor having:
a substantially planar surface with one or more fluid-conveying features for fluid communication with a stator,
wherein the fluid-conveying features are formed via an injection-compression molding process.

24. The rotor of claim 23, wherein the rotor is formed of a polymer filled with about 20% to about 50% carbon fiber by weight.

25. The rotor of claim 24, wherein the polymer is filled with about 30% carbon fiber by weight.

26. The rotor of claim 24, wherein the carbon fibers have a diameter in the range of about 6 microns to about 8 microns.

27. The rotor of claim 24, wherein the carbon fibers have a diameter of about 7 microns.

28. The rotor of claim 24, wherein the carbon fibers have a length in the range of about 0.002 inches to about 0.020 inches.

29. (canceled)

30. The rotor of claim 23, wherein the one or more fluid-conveying features comprise one or more arcuate grooves.

31. The rotor of claim 23, wherein the one or more fluid-conveying features have at least one of a width and a depth of less than about 0.020 inches.

32. The rotor of claim 23, wherein the one of more fluid conveying features have at least one of a width and depth of less than about 0.010 inches.

33. The rotor of claim 23, wherein the one or more fluid-conveying features have at least one of a width and a depth in the range of of about 0.005 inches to about 0.020 inches.

34. The rotor of claim 33, wherein the one or more fluid-conveying features have at least one of a width and a depth of about 0.008 inches.

35-36. (canceled)

37. The rotor of claim 23, wherein the one or more fluid conveying features have one or more dimensions that are about 0.010 inches or less in size.
